(19) United States
(12) Patent Application Publication
(10) Pub. No.: US 2004/0162135 A1
(43) Pub. Date: Aug. 19, 2004

(54) Credit system for gaming machines and gaming tables

(76) Inventors: Collette Flanagan-Parks, Dallas, TX (US); Susan Georgeson-Hopper, Plano, TX (US)

Correspondence Address: Michael A. O'Neil, Michael A. O'Neil, P.C., Suite 820, 5949 Sherry Lane, Dallas, TX, 75225, US

(21) Appl. No.: 10/779,043

(22) Filed: Feb. 13, 2004

Related U.S. Application Data
(63) Continuation-in-part of application No. 09/874,518, filed on Jun. 4, 2001, now Pat. No. 6,739,972.

(51) Int. Cl. G06F 17/00

(52) U.S. Cl. 463/25

(57) ABSTRACT

Gaming machine and gaming tables located within the premises of a gaming facility each have a credit system associated therewith. Each credit system includes a central processor unit, a financial card reader, a display and data input device, and a wireless transmitter/receiver operatively connected to the central processor unit for transmitting credit requests to a credit source and for receiving responses to previously transmitted credit requests. The wireless transmitter/receivers communicate with a wireless access gateway connected to a server which functions as a controller for all credit requests and responses thereto.

### CROSS-REFERENCE TO RELATED APPLICATIONS

This application is a continuation-in-part application of application Ser. No. 09/874,518 filed Jun. 4, 2001, currently pending.

### TECHNICAL FIELD

This invention relates generally to facilitating play at gaming machines and gaming tables, and more particularly to a method of and apparatus for establishing credit at the site of a gaming machine or a gaming table.

### BACKGROUND AND SUMMARY OF THE INVENTION

People throughout the world enjoy playing slot machines and other gaming machines at casinos and similar venues. Often a player will select a particular gaming machine and thereafter play the selected machine for an extended period of time thinking that by so doing the chances of winning a large jackpot are increased.

At the present time, however, if the player runs low on cash, it is necessary for the player leave the selected gaming machine in order to obtain additional cash, for example, from an ATM machine. Meanwhile, another player may take over the selected machine and win a jackpot in a relatively short time, much to the dismay of the original player.

Similar circumstances occur at gaming tables such as roulette tables, craps tables, blackjack tables, etc. A player at a gaming table that runs short of cash has two options available. One possibility is to leave the table in order to obtain cash from an ATM machine or other source. This opens the possibility that another player will take over the vacated seat at the gaming table. The other possibility is to obtain cash from the gaming table operator by signing a marker. The latter procedure is inconvenient in that it often requires as much as 15 minutes or more to complete.

The present invention comprises a credit system for gaming machines and gaming tables which overcomes the foregoing and other difficulties which long since characterized the prior art. In accordance with the broader aspects of the invention, individual gaming machines and gaming tables are provided with credit authorization facilities. More specifically, individual gaming machines and individual gaming tables are provided with financial card readers and associated display and data input apparatus. As used herein the term “financial card” means an ATM card, a credit card, a debit card, or any other type of card which facilitates communication with a credit source for purposes of establishing credit.

In accordance with the invention, a player utilizing a gaming machine or a gaming table utilizes the financial card reader located at the gaming machine or gaming table and the associated display and data input apparatus to establish communication with the credit source. The credit source in turn authorizes the requested credit. In the case of a gaming machine the credit is entered into the credit register of the machine thereby facilitating play. In the case of a gaming table a printer located at the gaming table generates a voucher which is exchanged for chips. In this manner a player utilizing a particular gaming machine or gaming table can obtain credit without leaving the gaming machine or gaming table and without waiting for a marker to be authorized.

Preferably the communication link that is established between the credit system of the present invention and a credit source includes a wireless link between each gaming machine and each gaming table that is equipped with the credit system of the present invention and a server located within the casino or other gaming venue. The server in turn establishes communication with the designated credit source. In this manner existing gaming machines and gaming tables can be retrofitted with the credit system of the present invention and newly manufactured gaming machines and gaming tables equipped with the credit system of the present invention can be installed in a gaming facility without the necessity of disrupting the facility to facilitate installation of hard wired connections to each gaming machine and each gaming table.

### BRIEF DESCRIPTION OF THE DRAWINGS

A more complete understanding of the invention may be had by reference to the following Detailed Description when taken in conjunction with the accompanying Drawings, wherein:

FIG. 1 is a diagrammatic illustration of the first embodiment of the apparatus of the present invention;

FIG. 2 is a diagrammatic illustration of the second embodiment of the apparatus of the invention;

FIG. 3 is a flowchart illustrating the first embodiment of the method of the invention;

FIG. 4 is a flowchart illustrating the second embodiment of the method of the invention;

FIG. 5 is a diagrammatic illustration of a wireless system for establishing communication between gaming machines and gaming tables equipped with the credit system of the present invention and a designated credit source; and

FIG. 6 is a diagrammatic illustration of a variation of the wireless communication illustrated in FIG. 5.

### DETAILED DESCRIPTION

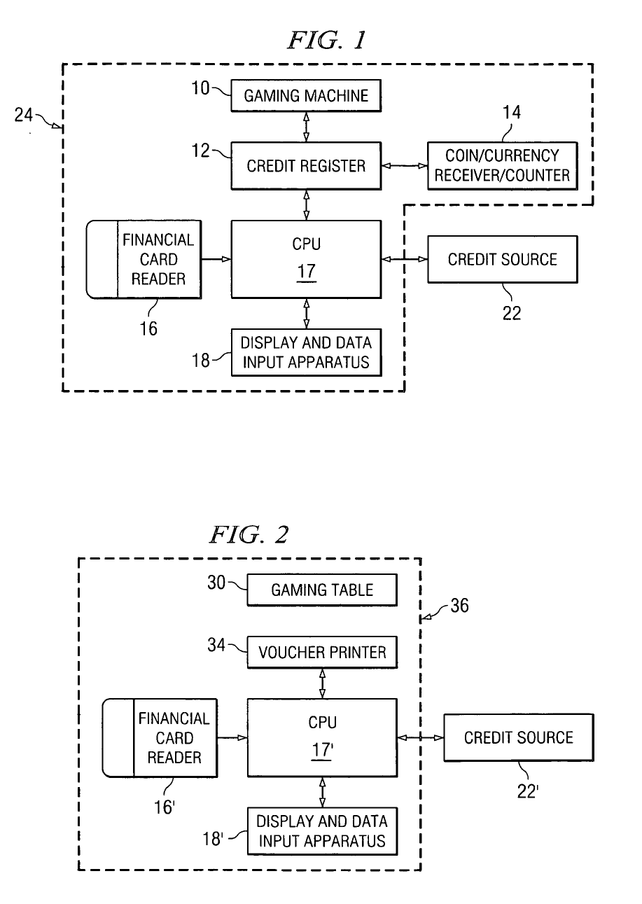

A first embodiment of the apparatus of the present invention is illustrated in FIG. 1. A gaming machine 10 can comprise a slot machine or any other conventional gaming machine or device. The gaming machine 10 is provided with a credit register 12 which controls the operation of the gaming machine 10. The gaming machine 10 is also provided with a coin/currency receiver/counter 14 the function of which is to receive, authenticate, and determine the value of coins and/or currency received therein.

In order to play the gaming machine 10 a player may deposit coins and/or currency into the coin/currency reader/counter 14. The value of the coins and/or currency deposited is communicated from the coin/currency reader/counter 14 to the credit register 12 thereby establishing a credit balance in the credit register in the amount of the value of the deposited coins and/or currency. Whenever there is a credit balance in the credit register 12 play of the gaming machine 10 is facilitated.

As play continues winnings resulted from play of the gaming machine 10 are added to the credit balance in the credit register 12. Similarly, losses resulting from play of the gaming machine are deducted from the credit balance in the credit register 12. If losses continue until the balance in the credit register is zero or nil, the credit register 14 disables the gaming machine 10.

In accordance with the present invention, the gaming machine 10 is provided with a financial card reader 16 individual to and located at the site of the gaming machine 10. As used herein the term “financial card” means an ATM card, a credit card, a debit card, or any other type of card which may be utilized to establish communication with a credit source for the purpose of obtaining credit. The financial card reader 16 is operatively connected to a central processor unit (CPU) 17 which contains or has access to software necessary for its operation.

The CPU 17 is also operatively connected to a display and data input apparatus 18 which is utilized in conjunction with the financial card reader 16. As will be appreciated by those skilled in the art, the display and data input apparatus 18 may comprise a CRT display, an LCD display, and LED display or any of the various other types of displays that are commonly utilized in association with ATM machines, computers, and the like. Likewise, the display and data input apparatus 18 may comprise a 10 key keyboard or any of the various other input devices commonly utilized in conjunction with ATM machines, computers, and the like.

Assume now that a player wishes to play the gaming machine 10 but does not have sufficient cash available to do so. The player inserts a financial card 20 into the financial card reader 16 and in conjunction therewith operates the display and data input apparatus 18 to establish communication with a credit source 22. As used herein the term “credit source” means an entity that can and will issue credit to the bearer of the financial card 20 responsive to various predetermined conditions, and is not limited to the entity which actually provided the financial card 20.

After establishing communication with the credit source 22, the player utilizes the display and data input apparatus 18 to indicate the amount of credit requested. Assuming that the various conditions necessary for the authorization of credit in the amount requested are met, the credit source 22 communicates a credit authorization through the CPU 17. In most cases the credit authorization results in a simultaneous deduction of the requested credit amount from an account maintained by the owner of the financial card 20 with the credit source 22.

Unlike an ATM machine, receipt by the CPU 17 of a credit authorization does not result in the issuance of currency. Rather, the requested credit amount as authorized by the credit source 22 is added to the credit register 12 by the CPU 17, thereby facilitating play of the gaming machine 10.

Assume further that the player that is utilizing the gaming machine 10 has been successful and the resulting winnings have been accumulated in the credit register 12. If the player wishes to discontinue playing the gaming machine 10, the player actuates the gaming machine to cash out. The term “cash out” is used herein in the same way that it is used in the gaming industry to mean giving the player coins, currency, and/or a voucher equal in value to the value stored in the credit register, and simultaneously debiting the credit register to zero.

The components parts of the credit system for gaming machines comprising the first embodiment of the invention are preferably housed in a unitary housing 24. In the case of a new gaming machine the housing 24 would be coincident with the housing of the gaming machine 10. In the case of existing gaming machines, the housing 24 could be an attachment to the housing of the gaming machine 10 or a separate structure positioned immediately adjacent to and secured to the housing of a gaming machine 10. As will be appreciated by those skilled in the art, when the present invention is utilized in conjunction with a gaming machine, the use of the coin/currency receiver/counter 14 can be dispensed with entirely.

Although the gaming machine 10, the credit register 12, the financial card reader 16, the CPU 17, and the display and data input apparatus 18 are depicted as separate structures in FIG. 1, those skilled in the art will appreciate the fact that there may be overlap in structure and function among the various components. For example, modern gaming machines are typically provided with a player's card slot which receives a player's card which records activities of the player at a particular casino or similar venue in a manner similar to a frequent flyer account with an airline. In accordance with the present invention it is contemplated that the player's card slot of the gaming machine can also function as the financial card reader. As is also well known, modern gaming machines include numerous electronic displays which can be utilized as part of the display and data input apparatus. Data input devices normally utilized in operating the gaming machine can also be incorporated as part of the display and data input apparatus. The financial card reader, the display and data input apparatus, and other components of the present invention can also comprise part of a commercially available device such as the POS terminal manufactured by Hypercom Corporation of Phoenix, Ariz. and identified by that company as ICE 4000.

A second embodiment of the apparatus of the present invention is illustrated in FIG. 2. Certain of the components parts of the second embodiment of the apparatus of the invention are substantially identical in construction and function to component parts of the first embodiment of the apparatus of the invention as illustrated in FIG. 1 and described hereinabove in conjunction therewith. Such identical component parts are designated in FIG. 2 with the same reference numerals utilized in the description thereof in conjunction with FIG. 1, but are differentiated thereof by a prime (′) designation.

The second embodiment of the apparatus of the present invention is utilized in conjunction with a gaming table 30 which may comprise a roulette table, a craps table, a blackjack table, or any other gaming table. A financial card reader 16′ is individual to and utilized solely in conjunction with an individual gaming table 30. A CPU 17′ is operatively connected to the financial card reader 16′. A display and data input apparatus 18′ is utilized in conjunction with the financial card reader 16′ and is operatively connected to the CPU 17′.

In the use of the second embodiment of the apparatus of the invention, a player seated at the gaming table 30 may need to purchased chips to begin or continue play. In any such event the player inserts his financial card 20′ into the financial card reader 16′ and utilizes the display and data input apparatus 18′ to establish communication with the credit source 22′ through the CPU 17′. When communication is established, the player utilizes the display and input device to communicate the amount of desired credit to the credit source 22′.

Assuming that the predetermined conditions for the issuance of credit to the owner of the financial card 20′ are fulfilled, the credit source 22′ transmits an authorization of the requested credit amount to the CPU 17′ which in turn relays the value of the authorized credit to a voucher printer 34. The voucher printer prints a voucher for the amount of the credit requested by the owner of the financial card 20′ and authorized by the credit source 22′. Upon completion of the printing of the voucher, a signal to the CPU 17′ cancelling the credit amount previously allocated. The voucher is exchanged for chips which allows the player to begin or continue playing at the gaming table 30.

It is contemplated that the component parts of the second embodiment of the apparatus of the present invention are contained within a unitary housing 36. In the case of a new gaming table 30, the housing 36 would be coincident with the structure of the gaming table. In the case of an existing gaming table 30, the housing 36 could comprise a separate structure secured to and operatively connected to the gaming table 30. The central processor unit, the financial card reader, the display and data input apparatus, the voucher printer and other components of the present invention can also comprise part of a commercially available device such as the POS terminal manufactured by Hypercom Corporation of Phoenix, Arizona and identified by that company as ICE 4000. It is further contemplated that individual gaming tables may be provided with a plurality of central processor unit/financial card reader/display and data input apparatus/voucher printer devices to accommodate the needs of players using the table.

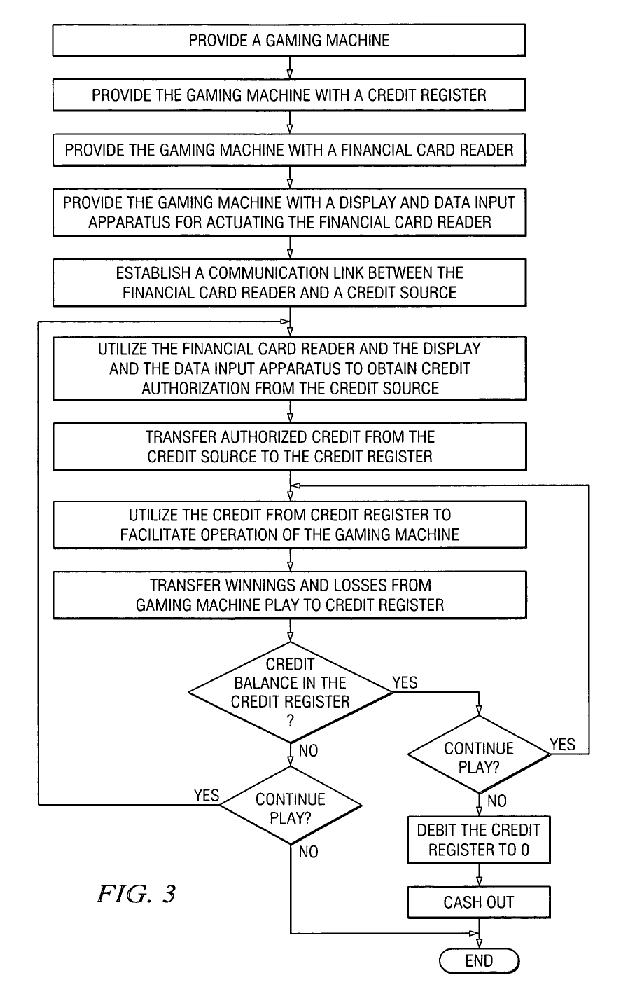

The first embodiment of the method of the present invention is illustrated in FIG. 3. In accordance with the first embodiment of the method, there is provided a gaming machine having a credit register operatively associated therewith. The gaming machine is provided with a financial card reader which is individual to and utilized solely in conjunction with the gaming machine. The gaming machine is further provided with a display and data input apparatus which is utilized to actuate the financial card reader.

In accordance with the first embodiment of the method of the invention, a player wishing to obtain credit for use in operating the gaming machine inserts a financial card into the financial card reader and thereafter utilizes the display and data input apparatus to obtain credit authorization from the credit source. More specifically, a central processor unit (CPU) and the display and data input apparatus are utilized to request authorization of a specific credit amount from the credit source.

Assuming the predetermined conditions are satisfied, the credit source authorizes credit in the requested amount. The authorized credit is transferred from the credit source to the credit register of the gaming machine. The transfer step may be accomplished utilizing the facilities of the CPU.

After the requested credit has been transferred from the account of the financial card owner with the credit source to the credit register of the gaming machine, the financial card owner plays the gaming machine. Winnings and losses resulting from the play of the gaming machine are transferred from the gaming machine to the credit register. To the extent that a credit balance is maintained in the credit register, the player has the option of either continuing or discontinuing play. In the event play is discontinued, the player actuates the display and data input apparatus and the CPU to cash out.

If the play of the gaming machine by the owner of the financial card results in losses which reduce the balance of the credit register of the gaming machine to zero, the player can decide either to continue play or to quit play. In the event the owner of the financial card elects to continue play, the financial card and the display and data input apparatus are once again utilized to obtain credit form the credit card issuer.

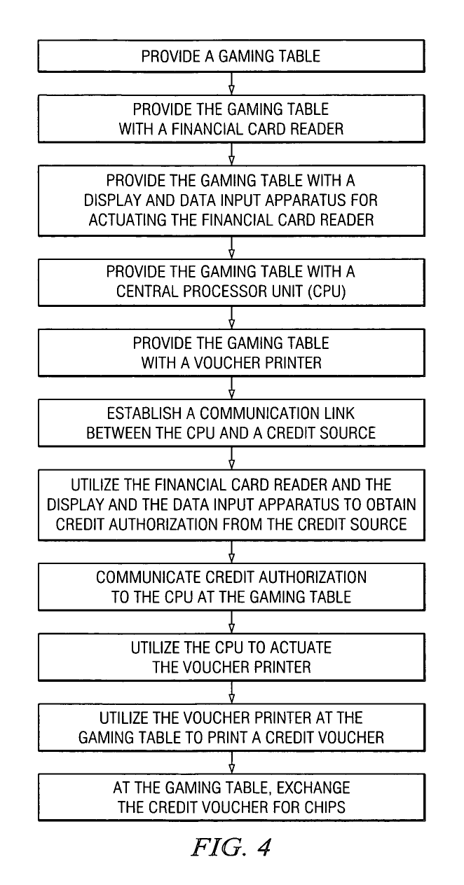

The second embodiment of the method of the invention as illustrated in FIG. 4. In accordance with the second embodiment of the invention, a gaming table is provided with a financial card reader and an associated display and data input apparatus. The gaming table is also provided with a voucher printer.

In the event the owner of a financial card requires credit either to begin or continue play at the gaming table, the financial card reader and the display and data input apparatus are utilized to establish a communication link between a central processor unit (CPU) and the credit source, and to request a designated amount of credit from the credit source. Assuming that predetermined conditions are established, the credit source establishes credit in the requested amount and subtracts the requested amount of credit from the account of the financial card owner with the credit source. The requested credit authorization is communicated from the credit source to the CPU at the gaming table. The CPU then actuates the voucher printer to print a credit voucher on behalf of the financial card owner. Simultaneously with completion of the printing step, a signal to the CPU which cancels the credit amount previously stored therein. At the gaming table the financial card owner exchanges the credit voucher for chips thereby facilitating play at the gaming table.

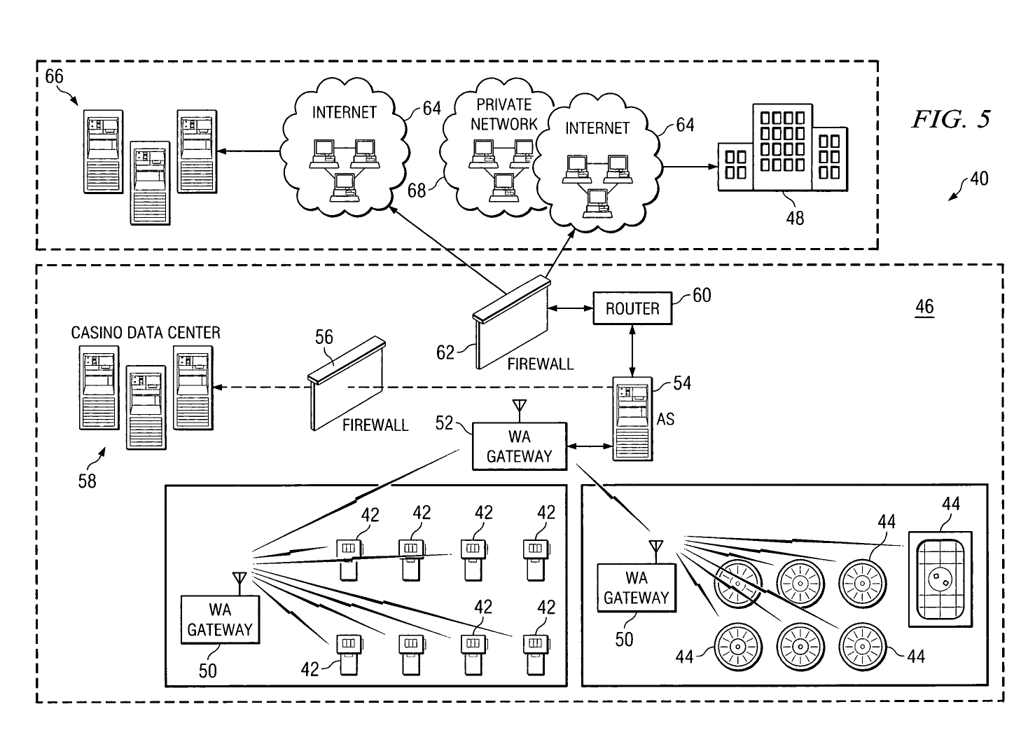

Referring to FIG. 5, there is shown a wireless communication system 40 useful in the practice of the present invention. A plurality of gaming machines 42 and a plurality of gaming tables 44 are located within the premises of a gaming facility 46, for example, a casino. Each of the gaming machines 42 is provided with a credit system constructed in accordance with the present invention and described hereinabove. Each of the gaming tables is provided with at least one credit system constructed in accordance with the present invention and described hereinabove. The credit systems of the present invention which are associated with the gaming machines 42 and with the gaming tables 44 are each provided with a wireless communication device which is utilized to establish communication between a particular gaming machine and a designated credit source 48 or between a particular gaming table and the credit source 48. Although only one credit source is shown in the drawings, those skilled in the art will understand that the wireless communication system 40 is capable of selectively communicating with an unlimited number of credit sources, and that the credit source 48 shown in the drawings is representative only.

In the embodiment of the invention shown in FIG. 5 the gaming machines 42 situated within the premises of the gaming facility 46 are arranged in clusters. An intermediate wireless access gateway 50 is associated with each cluster of gaming machines. Similarly the gaming tables located within the premises of the gaming facility 46 are arranged in clusters, and an intermediate wireless access gateway 50 is associated with each cluster of gaming tables.

Each intermediate wireless access gateway 50 in turn communicates with a master wireless access gateway 52. All transmissions from and to the credit systems associated with the gaming machines 42, the gaming tables 44, the wireless access gateways 50, and the wireless access gateway 52 are encrypted using conventional encryption techniques thereby preventing identity theft and similar problems. The master wireless access gateway 52 is connected in communication with an application server 54. The function of the application server 54 is to serve as the controller for all credit verification transactions.

The application server 54 collects all credit requests from each of the gaming machines 42 and from each of the gaming tables 44 located within the premises of the gaming facility 46, and routes each credit request to a designated credit source 48. The application server 54 also routes credit authorizations and denials back to the individual gaming machine 42 or to the individual gaming table 44 from which the credit request was originated. The application server 54 is adapted to handle thousands of transactions per second and can be appropriately scaled to handle the credit authorization needs of a particular gaming facility 46.

The application server 54 maybe connected through a firewall 56 to the data processing facilities 58 of the gaming facility 46. This allows transmission of certain data relating to the operation of the gaming machines 42 and the gaming tables 44 to the data processing facility 58. The firewall 56 prevents the gaming facility from having access to financial card data and other private information relating to users of the facility.

The application server 54 is also connected through a router 60, a firewall 62, and facilities 64 comprising the internet to the data processing facility 66 of the operator of the credit systems incorporating the present invention which are utilized within the premises of the gaming facility 46. This allows the operator to monitor each credit system to assure that it is operating properly and is properly communicating credit requests and responses thereto to and from designated credit sources.

Most importantly, the application server 54 is connected through the router 60 and the firewall 62 to the data processing facilities of each designated credit source 48 either through facilities 64 comprising the internet or through facilities 68 comprising a private network. In this manner the application server 54 functions to collect each credit request that it receives from the credit system of the present invention associated with one of the gaming machines 42 or with one of the gaming tables 44 and to direct each credit request to the designated credit source 48. Subsequently, the application server receives a response to the credit request, comprising either a credit authorization or a denial of credit from the designated credit source 48 and routes the response to the originating credit system. Assuming that credit is authorized the authorized credit amount is then added to the credit register of the originating credit system to facilitate gaming at the gaming machine 42 or at the gaming table 44 associated with the originating credit system. Conversely, if a particular credit request is denied by the credit source, the user of the gaming machine or gaming table associated with the originating credit system is so advised.

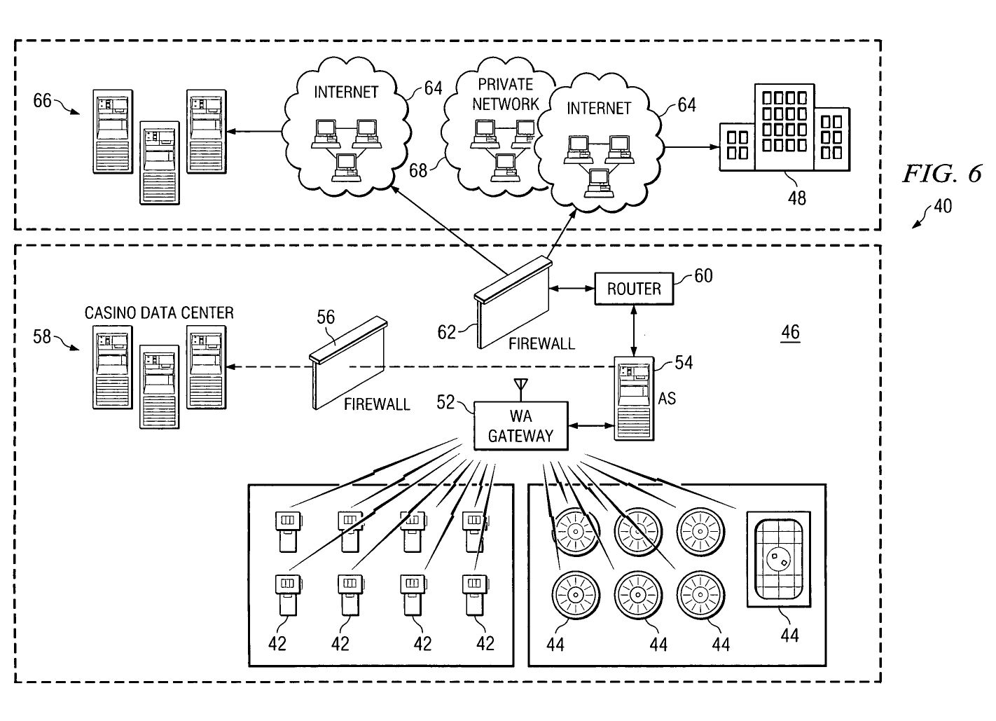

FIG. 6 illustrates a variation of the wireless communication system illustrated in FIG. 5 and described hereinabove in conjunction therewith. The variation of the wireless communication system shown in FIG. 6 is identical to the wireless communication system shown in FIG. 5 except that in the system of FIG. 6 the intermediate wireless access gateways 50 are illuminated. Thus, rather than communicating with the master wireless access gateway 52 through the intermediate wireless access gateways 50, the credit systems individual to each of the gaming machines 42 and each of the gaming tables 45 communicate directly with the master wireless access gateway 52.

By way of example only, and not by way of limitation, the following components may be utilized in the construction of the wireless communication systems shown in FIGS. 5 and 6:

| Component | Manufacturer |
|---|---|
| Intermediate Access | Cisco ® Aironet ® 1200 Series |
| Wireless Gateways 50 | Wireless Access Point |
| Master Wireless | Cisco ® Aironet ® 1200 or 1400 |
| Access Gateway 52 | Series Wireless Access Point |
| Application Server 54 | IBM ® p650 Server running AIX |
| | 5.2 operating system |
| Firewalls 56 and 62 | Cisco ® PIX 500 Series Firewall |
| Router 60 | Cisco ® 2600 Series Router |

Although preferred embodiments of the invention have been illustrated in the accompanying drawings and described in the foregoing Detailed Description, it will be understood that the invention is not limited to the embodiments disclosed, but is capable of numerous rearrangements, modifications, and substitutions of parts and elements without departing from the spirit of the invention.

We claim:

1. A system for facilitating the operation of a plurality of gaming machines located within the premises of a gaming facility comprising:
a plurality of credit systems each individual to one of the gaming machines and each including:
(a) a credit register individual to and operatively associated with a gaming machine for controlling the operation of the gaming machine;
(b) a central processor unit individual to the gaming machine and operatively connected to the credit register thereof;
(c) a financial card reader individual to the gaming machine and operatively associated with the central processor unit thereof;
(d) a display and data input apparatus individual to the gaming machine and operatively associated with the central processor unit thereof;
(e) the central processor unit responsive to inputs received from the financial card reader and from the display and data input apparatus for generating credit authorization requests and for receiving responses to previously generated credit authorization requests;
(f) a wireless transmitter/receiver for wirelessly transmitting credit authorization requests generated by the central processor unit and for wirelessly receiving responses to previously generated credit authorization requests;
a wireless access gateway for receiving wireless signals from the credit system associated with each of the gaming machines through the wireless transmitter/receivers thereof and for directing wireless transmissions to the credit systems associated with each of the gaming machines through the wireless transmitter/receivers thereof; and
a server operatively connected to the wireless access gateway for directing each credit request received from one of the credit systems associated with one of the gaming machines to the designated credit source and for subsequently directing responses to the credit requests received from the credit sources back to the originating credit systems through the wireless transmitter/receiver thereof.

2. The system according to claim 1 wherein each gaming machine has a housing and wherein the central processor unit, the financial card reader, and the display and data input apparatus of each credit system are mounted within the housing of the gaming machine individual to the credit system.

3. The credit system according to claim 1 wherein the gaming machine has a housing and further including a housing for the central processor unit, the financial card reader, and the display and data input apparatus of the credit system of the gaming machine which is secured to the housing of the gaming machine.

4. The system according to claim 1 wherein the multiplicity of gaming machines is divided into a at least two clusters and further including a plurality of intermediate wireless access gateways each associated with one of the clusters of gaming machines for receiving credit requests from the credit systems of the gaming machines within the associated cluster and for transmitting responses to credit requests back to the originating credit system and for relaying credit requests to and for receiving responses to credit requests from the wireless access gateway connected to the server.

5. In combination with a gaming machine of the type having a credit register, the improvement comprising:
a central processor unit individual to the gaming machine and operatively associated with the credit register thereof;
a financial card reader individual to the gaming machine and operatively associated with the central processor unit thereof;
a display and data input apparatus individual to the gaming machine and operatively associated with the central processor unit thereof;
the central processor unit for receiving data from the financial card reader and from the display and data input apparatus, for generating credit requests to be sent to a credit source, and for transferring credit from the credit source to the credit register of the gaming machine; and
a wireless transmitter/receiver operatively associated to the central processor unit for transmitting requests for credit to the credit source and for receiving responses to previously transmitted credit requests.

6. The credit system according to claim 5 wherein the gaming machine has a housing and wherein the central processor unit, the financial card reader, the display and data input apparatus, and the wireless transmitter/receiver are mounted within the housing of the gaming machine.

7. The credit system according to claim 5 wherein the gaming machine has a housing and further including a housing for the central processor unit, the financial card reader, the display and data input apparatus, and the wireless transmitter/receiver which is secured to the housing of the gaming machine.

8. A system for facilitating the operation of a plurality of gaming tables located within the premises of a gaming facility comprising:
a plurality of credit systems each individual to one of the gaming tables and each including:
(a) a central processor unit individual to and operatively associated with a gaming table;
(b) a financial card reader individual to the gaming table and operatively connected to the central processor unit thereof;
(c) a display and data input apparatus individual to the gaming table and operatively associated with the central processor unit thereof;
(d) the central processor unit for receiving data from the financial card reader from the display and data input apparatus and for generating credit authorization requests and for receiving responses to previously generated card authorization requests; and
(e) a wireless transmitter/receiver for wirelessly transmitting credit authorization requests generated by the central processor unit and for wirelessly receiving responses to previously generated credit authorization requests;
a wireless access gateway for receiving wireless signals from the credit system associated with each of the gaming tables through the wireless transmitter/receiver thereof and for directing wireless transmissions to the credit systems associated with each of the gaming tables through the wireless transmitter/receiver thereof; and
a server operatively connected to the wireless access gateway for directing each credit request received from one of the credit systems associated with one of the gaming tables to the designated credit source and for subsequently directing responses to the credit requests received from the credit source back to the originating credit systems through the wireless transmitter/receiver thereof.

9. The system according to claim 8 wherein each gaming table has a housing and wherein the central processor unit, the financial card reader, and the display and data input apparatus of each credit system are mounted within the housing of the gaming table individual to the credit system.

10. The credit system according to claim 8 wherein the gaming table has a housing and further including a housing for the central processor unit, the financial card reader, and the display and data input apparatus of the credit system of the gaming table which is secured to the housing of the gaming table.

11. The system according to claim 8 wherein the multiplicity of gaming tables is divided into a at least two clusters and further including a plurality of intermediate wireless access gateways each associated with one of the clusters of gaming tables for receiving credit requests from the credit systems of the gaming tables within the associated cluster and for transmitting responses to credit requests back to the originating credit system and for relaying credit requests to and receiving responses to credit requests from the wireless access gateway connected to the server.

12. In combination with a gaming table, the improvement comprising:
a central processor unit individual to the gaming table;
a financial card reader individual to and operatively associated with the central processor unit;
a display and data input apparatus individual to and operatively associated with the central processor unit;
the central processor unit for receiving data from the financial card reader and from the display and data input apparatus for generating credit requests and for receiving responses to previously generated credit requests;
a wireless transmitter/receiver operatively connected to the central processor unit for transmitting requests for credit to a credit source and for receiving responses to previously transmitted credit requests from the credit source; and
a voucher printer operatively connected to the central processor unit for printing credit vouchers responsive to credit approvals received by the central processor unit from the credit source.

13. The credit system according to claim 12 wherein the gaming table has a housing and wherein the central processor unit, the financial card reader, the display and data input apparatus, and the wireless transmitter/receiver are mounted within the housing of the gaming table.

14. The credit system according to claim 12 wherein the gaming table has a housing and further including a housing for the central processor unit, the financial card reader, the display and data input apparatus, and the wireless transmitter/receiver which is secured to the housing of the gaming table.

15. A credit system for gaming tables comprising:
a gaming table;
a central processor unit individual to the gaming table;
a voucher printer individual to the gaming table and operatively connected to the central processor unit thereof for printing credit vouchers;
a financial card reader individual to the gaming table and operatively connected to the central processor unit;
a display and data input device individual to the gaming table and operatively connected to the central processor unit;
the central processor unit for receiving data from the financial card reader and from the display and data input apparatus, for establishing communication with a credit source, for receiving a credit amount from the credit source; and for operating the credit voucher printer of the gaming table to print a credit voucher having a value equal to the amount of credit transferred from the credit source; and
a wireless transmitter/receiver operatively connected to the central processor unit for transmitting requests for credit to the credit source and for receiving responses to previously transmitted requests from the credit source.

16. The credit system according to claim 15 wherein the gaming table has a support structure and wherein the central processor unit, the credit voucher printer, the credit register, the financial card reader, and the display and data input apparatus are mounted within the support structure of the gaming table.

17. The credit system according to claim 15 wherein the gaming table has a support structure and wherein the central processor unit, the credit voucher printer, the credit register, the financial card reader, and the display and data input apparatus are mounted within a housing which is secured to the support structure of the gaming table.

18. A method of credit authorization for gaming machines including the steps of:
providing a gaming machine;
providing a credit register individual to and operatively associated with the gaming machine for controlling the operation of the gaming machine;
providing a central processor unit individual to the gaming machine and operatively connected to the credit register thereof;
providing a financial card reader individual to the gaming machine and operatively connected to the central processor unit thereof;
providing a display and data input apparatus individual to the gaming machine and operatively connected to the central processor unit;
utilizing the central processor unit to receive data from the financial card reader and from the display and data input apparatus and to generate requests for credit;
utilizing the central processor unit to transfer credit in a predetermined amount from the credit source to the credit register of the gaming machine; and
providing a wireless transmitter/receiver operatively connected to the central processor unit for transmitting requests for credit to a credit source and for receiving responses to previously transmitted requests from the credit source.

19. The method according to claim 18 wherein the step of providing the gaming machine is further characterized by providing the gaming machine having a housing and including the additional step of mounting central processor unit, the financial card reader, and the display and data input apparatus within the housing of the gaming machine.

20. The method according to claim 18 wherein the step of providing the gaming machine is further characterized by providing the gaming machine having a housing and including the additional steps of mounting the central processor unit, the financial card reader, and the display and data input apparatus in an auxiliary housing, and securing the auxiliary housing to the housing of the gaming machine.

21. A method of providing credit at a gaming table including the steps of:
providing the game table;
providing a credit voucher printer individual to and located at the site of the gaming table;
providing a central processor unit individual to and located at the site of the gaming table;
providing a financial card reader individual to and located at the site of the gaming table;
providing a display and data input apparatus individual to and located at the site of the gaming table;
providing a wireless transmitter/receiver individual to and located at the site of the gaming table and operatively connected to the central processor unit;
utilizing the central processor unit to receive data from the financial card reader and display and data input apparatus and to establish communication with a credit source and to transfer a requested credit amount from the credit source to the credit voucher printer;
utilizing the wireless transmitter/receiver to transmit requests for credit from the central processor unit to a credit source and for receiving responses to requests for credit from the credit source; and
thereafter utilizing the credit voucher printer to print a credit voucher.

22. The credit authorization system for gaming tables according to claim 21 wherein the step of providing a gaming table is further characterized by the step of providing a gaming table having a support structure and including the additional step of mounting the credit voucher printer, the central processor unit, the financial card reader, and the display and data input apparatus within the housing of the gaming table.

23. The credit authorization system according to claim 21 wherein the step of providing a gaming table is further characterized by providing a gaming table having a support structure and including the additional steps of mounting the credit voucher printer, the central processor unit, the financial card reader, and the display and data input apparatus in a housing and securing the housing to the support structure of the gaming table.
